(19) United States
(12) Patent Application Publication
(10) Pub. No.: US 2021/0368768 A1
(43) Pub. Date: Dec. 2, 2021

(54) PORTABLE FLYING INSECT VACUUM DEVICE

(71) Applicant: Gainson Fan Fan, Kissimmee, FL (US)

(72) Inventor: Gainson Fan Fan, Kissimmee, FL (US)

(21) Appl. No.: 16/888,793

(22) Filed: May 31, 2020

(51) Int. Cl. A01M 3/00

(52) U.S. Cl. CPC A01M 3/005; A47L 9/2884; A01M 2200/012

(57) ABSTRACT

The flying insect vacuum device removes annoying insects, and particularly flying insects such as flies, from inside or outside of the home or anywhere else they might show up. The flying insect vacuum device is a portable handheld unit with a handle, battery, and eject battery button on the backside of the device. The power button turns the vacuum motor on and off. On the front of the invention is a large grill over a funnel that sucks the flies into a storage compartment in the center of the device. The device has strong vacuum suction, an adjustable front suction tool, an insect trapping compartment, and a quick release on and off button.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of portable vacuum devices and more specifically relates to a fly vacuum—that is, a vacuum that vacuums up a fly or other flying insect.

### 2. DESCRIPTION OF THE RELATED ART

Flies buzzing around food and people's heads are a well-established problem with backyard barbeques, dinners, and picnics. The sound of their wings is irritating to most people, and the sight of them landing on food is often sufficient to make people not want to eat. Swatting at them may temporarily cause them to buzz off, but they'll just keep coming back.

People have tried a number of ways of dealing with flying pests when dining al fresco. In some places, it's common to cover all the food dishes with a rigid plastic netting dome, but as the netting dome has to be lifted every time someone wants to help themselves to the dish below it, flies can still find an opportunity to sneak under the dome and get to the food. Citronella candles are another common way of attempting to discourage flies, but some people find the scent of citronella overwhelming and unpleasant. Furthermore, citronella is not advised for indoor use, so it can't help if flies get inside your house. Fly zappers, electrical devices that electrocute insects that fly into the device, are effective, but the unpleasant sound associate with them, and the resulting litter of insect bodies around the fly zapper, put many people off of such devices.

Various other attempts have been made to solve the problems that may be found in the related art but have thus far been unsuccessful. A need exists for a reliable flying insect vacuum device to avoid the above-mentioned problems.

Ideally, a flying insect vacuum device should provide an easy way of vacuuming up pestering flying insects wherever needed and, yet would operate reliably and be manufactured at a modest expense. Thus, a need exists for a reliable flying insect vacuum device to avoid the above-mentioned problems.

### BRIEF SUMMARY OF THE INVENTION

In view of the foregoing disadvantages inherent in the known art, the present invention provides a novel flying insect vacuum device. The general purpose of the present invention, as will be described subsequently in greater detail, is to provide a vacuum capable of vacuuming up flying insects such as flies. The features of the invention that are believed to be novel are particularly pointed out and distinctly claimed in the concluding portion of the specification. These and other features, aspects, and advantages of the present invention will become better understood with reference to the following drawings and detailed description.

The flying insect vacuum device is designed to help remove annoying insects, and particularly flying insects such as flies, from inside or outside of the home, at family functions, or anywhere else they might show up. The flying insect vacuum device is a portable handheld unit with a ribbed handle, battery, and eject battery button on the backside of the device. The power button is on top of the handle. On the front of the invention is a large grill that sucks the flies into a storage compartment in the center of the device.

The device has strong vacuum suction, an adjustable front suction tool, an insect trapping compartment, and a quick release on and off button. The device allows user to quickly and easily trap and remove flying insects in any location.

The present invention holds significant improvements and serves as a flying insect vacuum device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a flying insect vacuum device, constructed and operative according to the teachings of the present invention.

FIG. 1 shows a perspective view illustrating a flying insect vacuum device according to an embodiment of the present invention.

FIG. 2 is a perspective view illustrating a flying insect vacuum device according to an embodiment of the present invention of FIG. 1.

FIG. 3 is a perspective view illustrating a flying insect vacuum device according to an embodiment of the present invention of FIG. 1.

The various embodiments of the present invention will hereinafter be described in conjunction with the appended drawings.

### DETAILED DESCRIPTION

As discussed above, embodiments of the present invention relate to a vacuum and more particularly to a flying insect vacuum device as used to improve the ability of a user to catch and remove flying insects inside or outside a building.

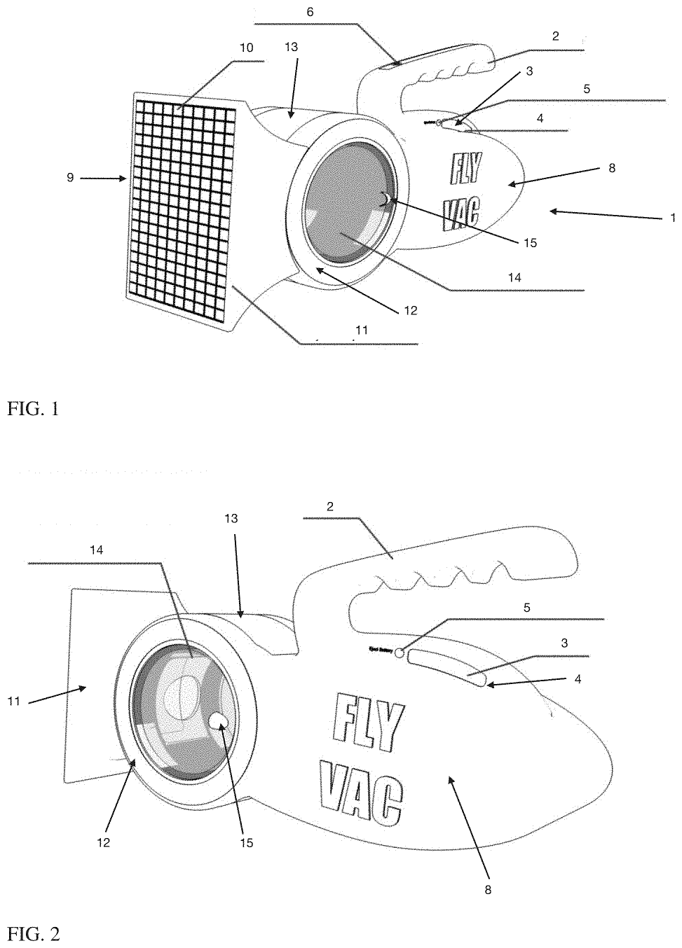

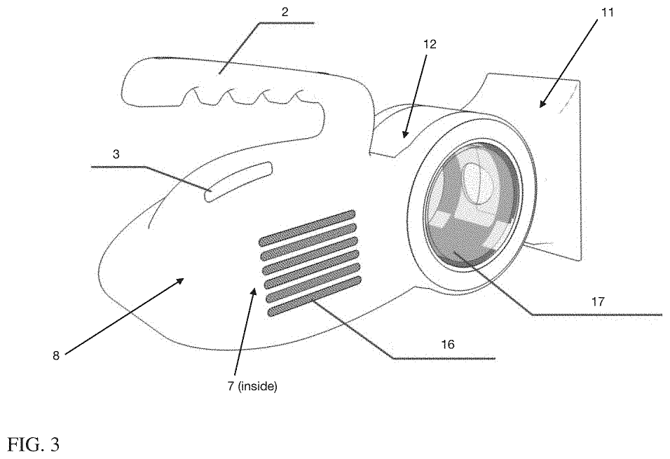

Referring now to the drawings FIGS. 1-3, the flying insect vacuum device is designed to help remove annoying insects, and particularly flying insects such as flies, with a simple push of a button, from inside or outside of the home, at family functions, or anywhere else they might show up. The flying insect vacuum device has a portable handheld body unit 1 with a handle 2, removable battery 3 that slots into a battery slot 4, and eject battery button 5 that ejects the removable battery 3 from the slot 4 in the body 1 when pushed. The handle 2 is preferably ribbed. The eject battery button 5 is preferably located on a top surface of the body 1, next to the battery slot 4. A power button 6 that controls the on-off of the vacuum motor 7 is preferably located on a top surface of the handle 2. The vacuum motor 7 is housed inside the body 1 in a back section 8. Exhaust vents 16 are located in a side of the back section 8 of the body 1 to vent the vacuum motor 7.

Attached to the front section 9 of the body 1 is a large grill 10 over a funnel portion 11, arranged so that when the vacuum motor 7 is on, air is sucked through the grill 10, through the funnel portion 11, and then into a trap compartment 12, where the flying insects are housed so as to prevent them from being further sucked into the vacuum motor 7. The grill 10 helps to keep the insects inside the trap compartment 12.

The trap compartment 12 is located between the funnel portion 11 that attaches to the front portion 9 and the vacuum motor 7 in the back portion 8, in a center portion 13. The trap compartment 12 has a compartment door 14 on at least on side of the center portion 13, with a compartment doorknob 15 located thereon. A user can open the compartment door 14 to release any live insects within the trap compartment 12, or clean out any dead insects. The compartment door 14 is preferable translucent, and even more preferably clear. Alternately, as shown in FIG. 3, the trap compartment 12 may have a compartment door 14 on one side, and a translucent or clear, non-moveable compartment window 17 on the other side. The compartment window 17 does not have a knob, as it does not move, but rather allows the user to see into the trap compartment 12 from either side of the body 1 of the device.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A portable flying insect vacuum device comprising:
(a) a main body having a front part, a back part, and a center part;
(b) a handle operably connected to the main body so that a user can lift and move the main body via the handle;
(c) a battery slot operably positioned on the main body to receive a removable battery;
(d) an eject-battery button operably connected to the battery slot so that the removable battery is ejected when the eject-battery button is pushed;
(e) a trap compartment operably located in the center part of the main body, having
(i) an openable compartment door operably connected on a first side of the trap compartment with a compartment doorknob thereon so that the compartment door is openable to empty any insects within the trap compartment; and
(ii) a second openable compartment door or a non-moveable compartment window operably located on a second side of the trap compartment;
(f) a funnel part operably connected to the front part of the main body so that a narrow end of the funnel part opens into the trap compartment;
(g) a grill operably connected to a wide end of the funnel part;
(h) an exhaust vent operably positioned in a side of the back section of the main body;
(i) a vacuum motor operably housed within the back part of the main body,
wherein the vacuum motor is operably connected to the battery so that the vacuum motor is powered by the battery,
wherein the vacuum motor is operably connected to the exhaust vent so that the vacuum motor vents through the exhaust vent, and
wherein the vacuum motor is operably positioned within the back part of the main body to create a suction current through the funnel part into the trap compartment so that insects are pulled through the grill into the funnel part and then into the trap compartment; and
(j) an on-off button operably connected to the vacuum motor to turn the vacuum motor on and off.

2. The portable flying insect vacuum device according to claim 1, wherein the on-off button is operably positioned on the handle so that the on-off button is operable by a user holding the flying insect vacuum device by the handle.

3. The portable flying insect vacuum device according to claim 1, wherein the handle is ribbed to improve grip.

4. The portable flying insect vacuum device according to claim 1, wherein the openable compartment door and the second openable compartment door or the openable compartment door and the non-moveable compartment window are formed of a clear material so any insects in the trap compartment are visible to a user.

5. A portable flying insect vacuum device comprising:
(a) a main body having a front part, a back part, and a center part;
(b) a handle operably connected to the main body so that a user can lift and move the main body via the handle,
wherein the handle is ribbed to improve grip;
(c) a battery slot operably positioned on the main body to receive a removable battery;
(d) an eject-battery button operably connected to the battery slot so that the removable battery is ejected when the eject-battery button is pushed;
(e) a trap compartment operably located in the center part of the main body, having
(i) an openable compartment door operably connected on a first side of the trap compartment with a compartment doorknob thereon so that the compartment door is openable to empty any insects within the trap compartment; and
(ii) a non-moveable compartment window operably located on a second side of the trap compartment,
wherein the openable compartment door and the second openable compartment door or the openable compartment door and the non-moveable compartment window are formed of a clear material so any insects in the trap compartment are visible to a user;
(f) a funnel part operably connected to the front part of the main body so that a narrow end of the funnel part opens into the trap compartment;
(g) a grill operably connected to a wide end of the funnel part;
(h) an exhaust vent operably positioned in a side of the back section of the main body;
(i) a vacuum motor operably housed within the back part of the main body,
wherein the vacuum motor is operably connected to the battery so that the vacuum motor is powered by the battery,
wherein the vacuum motor is operably connected to the exhaust vent so that the vacuum motor vents through the exhaust vent, and
wherein the vacuum motor is operably positioned within the back part of the main body to create a suction current through the funnel part into the trap compartment so that insects are pulled through the grill into the funnel part and then into the trap compartment; and
(j) an on-off button operably connected to the vacuum motor to turn the vacuum motor on and off,
wherein the on-off button is operably positioned on the handle so that the on-off button is operable by a user holding the flying insect vacuum device by the handle.
